(19) United States
(12) Patent Application Publication
(10) Pub. No.: US 2009/0254822 A1
(43) Pub. Date: Oct. 8, 2009

(54) HI-EFFICIENCY WIZARD FRAMEWORK SYSTEM AND METHOD

(75) Inventor: KENNETH L. GREENLEE, Raleigh, NC (US)

Correspondence Address: HOLLAND & KNIGHT LLP, 10 ST. JAMES AVENUE, BOSTON, MA, 02116, US

(73) Assignee: International Business Machines Corporation, Armonk, NY (US)

(21) Appl. No.: 12/098,031

(22) Filed: Apr. 4, 2008

(51) Int. Cl. G06F 3/048

(52) U.S. Cl. 715/708

(57) ABSTRACT

A method and computer program product for defining a first data request for presentation within a wizard. The first data request solicits a first response from a user of the wizard. At least a second data request is defined for presentation within the wizard after receipt of the first response from the user. The at least a second data request solicits at least a second response from the user of the wizard. A computing device is defined as the intended recipient of the first response and the at least a second response. The first response and the at least a second response are concurrently provided to the computing device.

### BACKGROUND OF THE INVENTION

This disclosure relates to wizard frameworks and, more particularly, to highly-efficient wizard frameworks.

Many computer-based applications use one or more wizards to guide a user through a process. One or more frameworks may be used to design and implement the above-described wizards, which may e.g., include a plurality of wizard pages that are accessed during use of the wizard. For example, a wizard may prompt a user for a specific piece of information and, upon providing that information, the user may select a “next” button that renders the appropriate next page chosen from the plurality of pages. The next page rendered may prompt the user for one or more additional pieces of information.

Prior to advancing to the next page of the wizard, a validation process may be executed that ensures that the user has met the requirement(s) for proceeding to the next page. For example, if the first page of a wizard asks for the user's email address, prior to advancing to the next page within the wizard, the specific wizard may confirm that the user has indeed entered their email address.

Web applications may use various page types (e.g., HTML/JSP pages) to process and manage propagation through the pages of the wizard. Unfortunately, such an implementation may require a call to a server-side component (e.g., a servlet). Accordingly and unfortunately, the performance of the wizard is now tied to the speed of the network and server-side processing performance.

### BRIEF SUMMARY OF THE INVENTION

In a first implementation, a method includes defining a first data request for presentation within a wizard. The first data request solicits a first response from a user of the wizard. At least a second data request is defined for presentation within the wizard after receipt of the first response from the user. The at least a second data request solicits at least a second response from the user of the wizard. A computing device is defined as the intended recipient of the first response and the at least a second response. The first response and the at least a second response are concurrently provided to the computing device.

In another implementation, a computer program product resides on a computer readable medium that has a plurality of instructions stored on it. When executed by a processor, the instructions cause the processor to perform operations including defining a first data request for presentation within a wizard. The first data request solicits a first response from a user of the wizard. At least a second data request is defined for presentation within the wizard after receipt of the first response from the user. The at least a second data request solicits at least a second response from the user of the wizard. A computing device is defined as the intended recipient of the first response and the at least a second response. The first response and the at least a second response are concurrently provided to the computing device.

One or more of the following features may be included. The at least a second data request may be based, at least in part, upon the first response from the user of the wizard.

Concurrently providing the first response and the at least a second response to the computing device may include receiving and storing the first response. The at least a second response may be received and stored. The first response and the at least a second response may be combined to form a combined response. The combined response may be provided to the computing device.

Concurrently providing the first response and the at least a second response to the computing device may include receiving and storing the first response. The at least a second response may be received and stored. The first response and the at least a second response may be sequentially provided to the computing device.

Concurrently providing the first response and the at least a second response to the computing device may include providing the first response to the computing device only after the at least a second response is received from the user.

The wizard may be a multi-page wizard that defines a first wizard page and at least a second wizard page. The first data request may be defined within the first wizard page. The at least a second data request may be defined within the at least a second wizard page. The computing device may be a webserver. The wizard may be a JavaScript-based wizard.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is a diagrammatic view of a wizard framework process coupled to a distributed computing network;

FIG. 2 is a flowchart of the wizard framework process of FIG. 1;

FIG. 3 is a diagrammatic view of a wizard page rendered by a wizard configured using the wizard framework process of FIG. 1;

FIG. 4 is a diagrammatic view of another wizard page rendered by a wizard configured using the wizard framework process of FIG. 1;

FIG. 5 is a diagrammatic view of another wizard page rendered by a wizard configured using the wizard framework process of FIG. 1;

FIG. 6 is a diagrammatic view of another wizard page rendered by a wizard configured using the wizard framework process of FIG. 1; and

FIG. 7 is a diagrammatic view of another wizard page rendered by a wizard configured using the wizard framework process of FIG. 1;

Like reference symbols in the various drawings indicate like elements.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in a web-based language, such as JavaScript, as well as an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

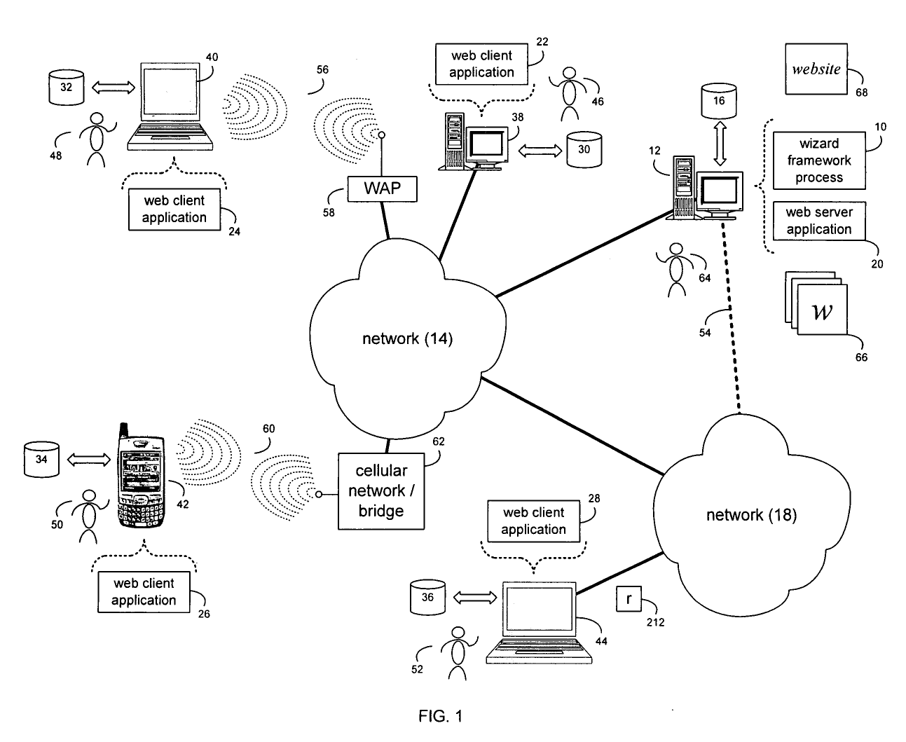

Referring to FIG. 1, there is shown wizard framework process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example.

As will be discussed below in greater detail, wizard framework process 10 may define a first data request for presentation within a wizard. The first data request may solicit a first response from a user of the wizard. One or more additional data requests may be defined for presentation within the wizard after receipt of the first response from the user. The one or more additional data requests may solicit one or more additional responses from the user of the wizard. A computing device may be defined as the intended recipient of the first response and the one or more additional responses. The first response and the one or more additional responses may be concurrently provided to the computing device.

The instruction sets and subroutines of wizard framework process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute web server application 20, examples of which may include but are not limited to: Microsoft IIS™, Novell Webserver™, or Apache Webserver™, that allows for HTTP (i.e., HyperText Transfer Protocol) access to server computer 12 via network 14. The instruction sets and subroutines of web server application 20, which may be stored on storage device 16 coupled to server computer 12, may be executed by one or more processors (not shown) and one or more memory architectures (not shown) incorporated into server computer 12.

Network 14 may be connected to one or more secondary networks (e.g., network 18), examples of which may include but are not limited to: a local area network; a wide area network; or an intranet, for example. Wizard framework process 10 may be a stand alone application that interfaces with web server application 20 or an applet/application that is executed within web server application 20.

The instruction sets and subroutines of web client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of web client applications 22, 24, 26, 28 may include Microsoft Internet Explorer™, Apple Safari™, and Mozilla FireFox™.

Examples of computing devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using web client applications 22, 24, 26, 28, users 46, 48, 50, 52 may allow access to one or more applications resident on and served by e.g., server computer 12 and/or web server application 20.

Users 46, 48, 50, 52 may access web server application 20 directly through the device on which the web client application (e.g., web client applications 22, 24, 26, 28) is executed, namely client electronic devices 38, 40, 42, 44, for example. Users 46, 48, 50, 52 may access web server application 20 directly through network 14 or through secondary network 18. Further, server computer 12 (i.e., the computer that executes web server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

For the following discussion, web client application 22 is going to be described for illustrative purposes. However, this is not intended to be a limitation of this disclosure, as other web client applications (e.g., web client applications 24, 26, 28) may be equally utilized.

As discussed above, wizard framework process 10 may define a first data request for presentation within a wizard. The first data request may solicit a first response from a user of the wizard. One or more additional data requests may be defined for presentation within the wizard after receipt of the first response from the user. The one or more additional data requests may solicit one or more additional responses from the user of the wizard. A computing device may be defined as the intended recipient of the first response and the one or more additional responses. The first response and the one or more additional responses may be concurrently provided to the computing device.

Administrator 64 of wizard framework process 10 may utilize wizard framework process 10 to generate one or more wizard 66 for use in conjunction with one or more applications resident on and served by e.g., web server application 20. While wizard framework process 10 and webserver application 20 are described above as being executed on a single computer (i.e., server computer 12), this is for illustrative purposes only, as other configurations are possible. For example, wizard framework process 10 and webserver application 20 may each be executed on separate computers.

As discussed above, wizards may include a plurality of pages that are accessed during use of the wizard. For example, a wizard may prompt a user for a specific piece of information and, upon providing that information, the user may select a “next” button that renders the next page in the plurality of pages (which may prompt the user for one or more additional pieces of information).

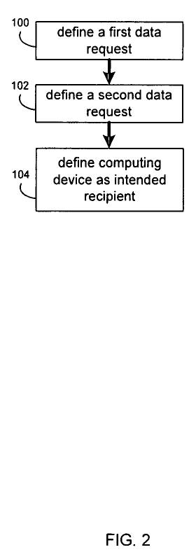

Referring also to FIG. 2, when designing a wizard (e.g., wizard 66) using wizard framework process 10, administrator 64 may define 100 a first data request for presentation within wizard 66. This first data request may solicit a first response from a user (e.g., user 46) of the wizard.

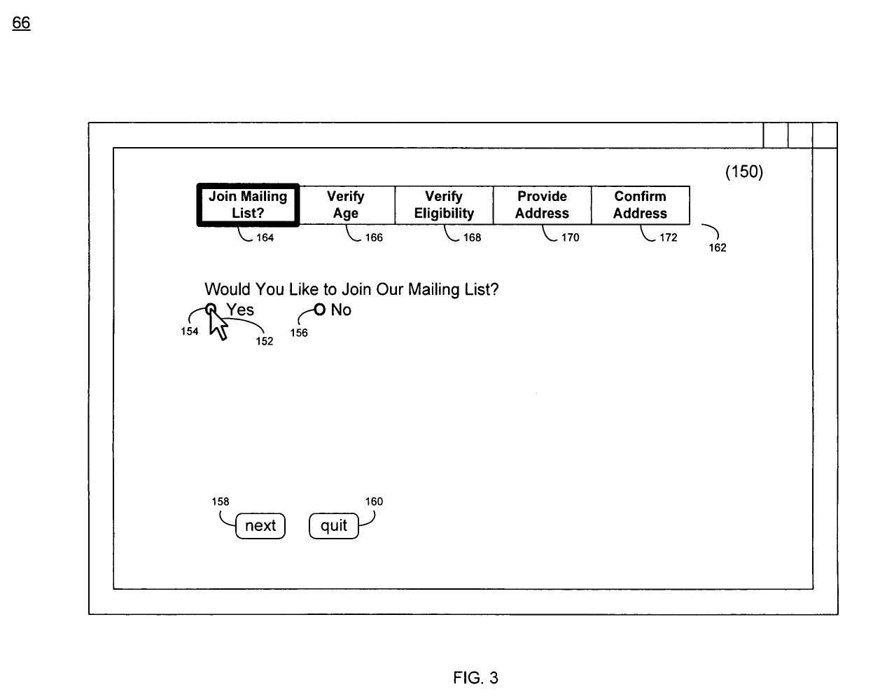

For example and referring also to FIG. 3, assume that administrator 64 wishes to design a wizard (e.g., wizard 66) that facilitates people joining a mailing list via e.g., a web-based application served using web server application 20. Accordingly, administrator 64 may use wizard framework process 10 to define 100 the first data request (“Would You Like to Join Our Mailing List?) for presentation within e.g., first wizard page 150 of wizard 66. This first data request may solicit a first response from a user (e.g., user 46) of wizard 66. Accordingly, the user (e.g., user 46) of wizard 66 may select via onscreen pointer 152 (which may be controllable by a pointing device; not shown) either “Yes” button 154 or “No” button 156.

When configuring wizard 66 using wizard framework process 10, administrator 64 may include within wizard page 150 one or more buttons that allow user 46 to navigate wizard 66. For example, once the appropriate response (either “Yes” button 154 or “No” button 156) is selected by user 46, the user of wizard 66 may select e.g., “next” button 158 to proceed to the next page of wizard 66. Alternatively, wizard page 150 of wizard 66 may be configured by administrator 64 to include “quit” button 160 that allows user 46 to exit wizard 66.

Once “next” button 158 of wizard 66 is selected, the next page of wizard 66 may be rendered. When configuring wizard 66 using wizard framework process 10, administrator 64 may configure wizard 66 to confirm that the user of the wizard has provided e.g., the first response solicited by the first request. For example, wizard 66 may be configured to only allow user 46 to select “next” button 158 once user 46 selects either “Yes” button 154 or “No” button 156 in response to the first data request (“Would You Like to Join Our Mailing List?).

When configuring wizard 66 using wizard framework process 10, administrator 64 may configure wizard 66 to include status bar 162 that may allow e.g., user 46 of wizard 66 to visually monitor their progress within wizard 66. In this particular embodiment, status bar 162 is shown to include five (5) discrete sections, one of which corresponds to the five (5) discrete wizard pages included within wizard 66. Accordingly, when configuring wizard 66 using wizard framework process 10, administrator 64 may configure status bar 162 to highlight/identify the particular wizard page that e.g., user 46 is currently working on.

When configuring wizard 66 using wizard framework process 10, administrator 64 may define 102 at least a second data request for presentation within wizard 66 after receipt of the first response from the user (e.g., user 46) of wizard 66. The data requests may each solicit a response from the user of wizard 66. As discussed above and in this particular example, wizard 66 includes five (5) discrete wizard pages. Accordingly, when configuring wizard 66, administrator 64 may configure five specific requests (i.e., one for each discrete wizard page).

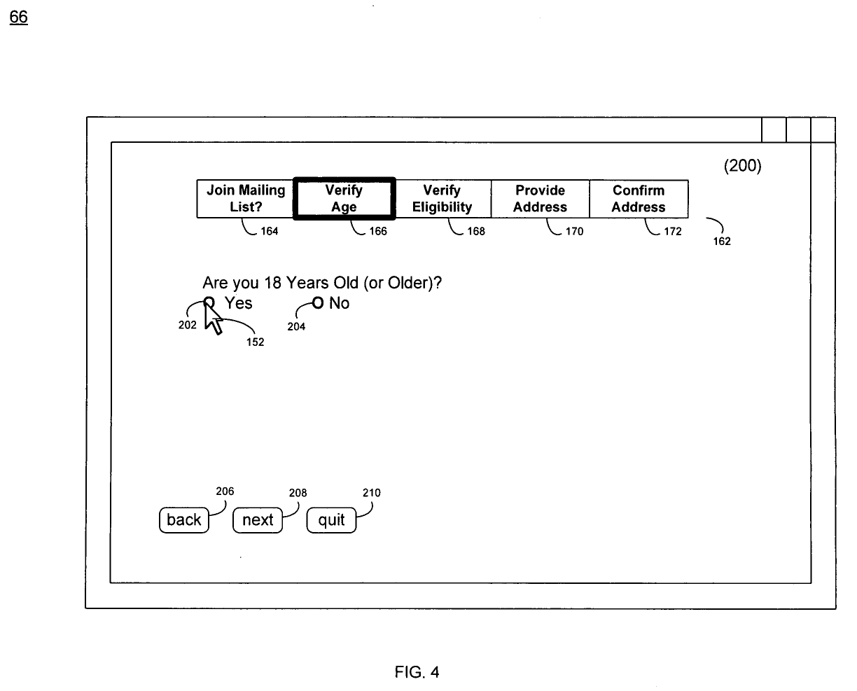

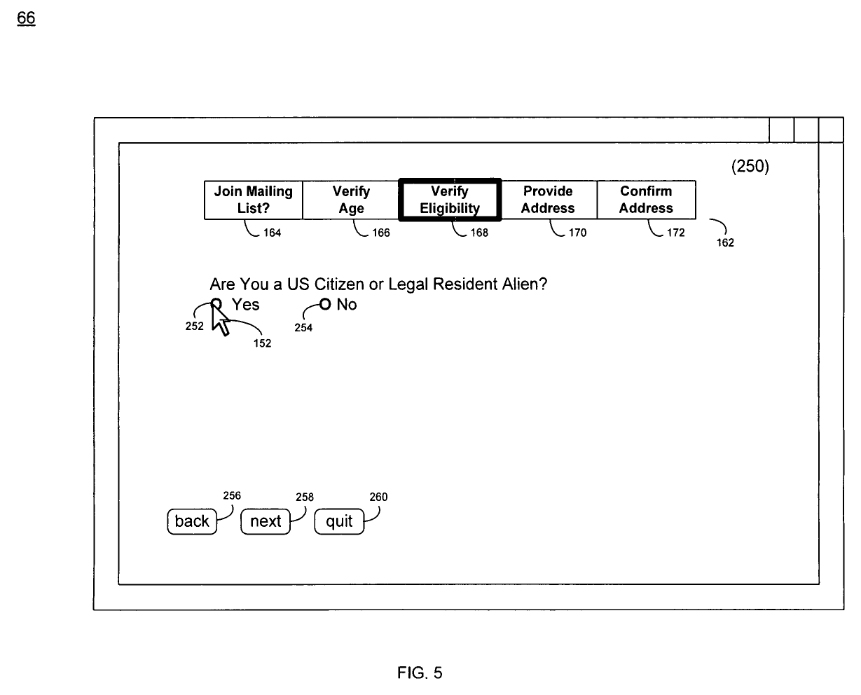

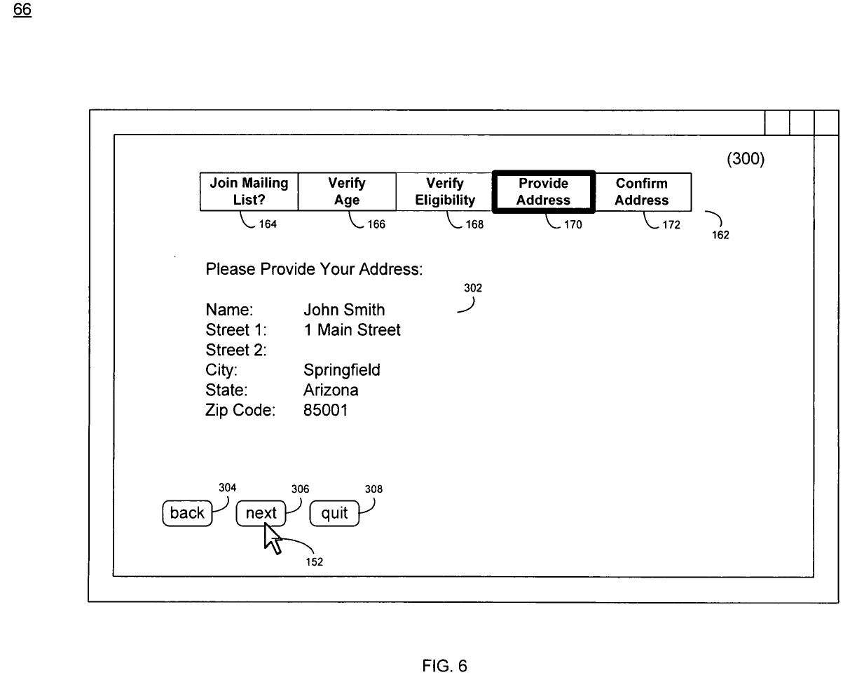

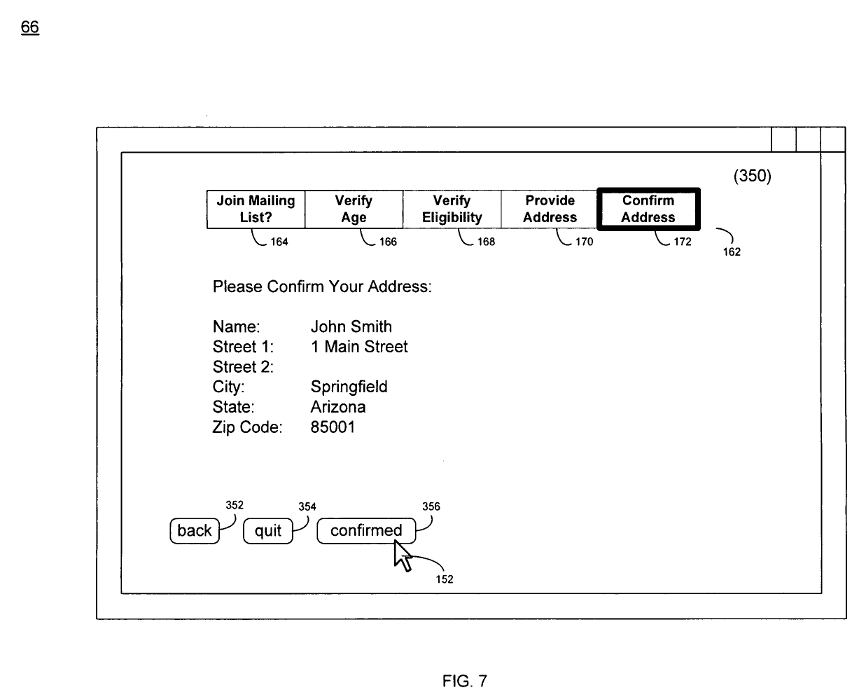

Referring also to FIGS. 4-7, upon user 46 selecting “next” button 158 on wizard page 150, wizard page 200 may be rendered. Continuing with the above-stated example, administrator 64 may use wizard framework process 10 to define 102 the additional data requests (“Are You 18 Years Old or Older?”) for presentation within e.g., second wizard page 200 of wizard 66; (“Are You a US Citizen or Legal Resident Alien?”) for presentation within e.g., third wizard page 250 of wizard 66; (“Please Provide Your Address”) for presentation within e.g., fourth wizard page 300 of wizard 66; and (“Please Confirm Your Address”) for presentation within e.g., fifth wizard page 350 of wizard 66.

Each of the above-described data requests may solicit a unique response from the user (e.g., user 46) of wizard 66. For example, the data request “Are You 18 Years Old or Older?” (as included within e.g., second wizard page 200 of wizard 66) may require that user 46 select either “Yes” button 202 or “No” button 204; followed by a selection of either “back” button 206, “next” button 208, or “quit” button 210. As discussed above, administrator 64 may use wizard framework process 10 to configure wizard 66 to only allow user 46 to select “next” button 208 once user 46 selects either “Yes” button 202 or “No” button 204 in response to the data request “Are You 18 Years Old or Older?”.

Continuing with the above-stated example, upon user 46 selecting “next” button 208 on second wizard page 200, third wizard page 250 of wizard 66 may be rendered that includes the data request “Are You a US Citizen or Legal Resident Alien?”The data request “Are You a US Citizen or Legal Resident Alien?” (as included within e.g., third wizard page 250 of wizard 66) may require that user 46 select either “Yes” button 252 or “No” button 254; followed by a selection of either “back” button 256, “next” button 258, or “quit” button 260. Again, administrator 64 may use wizard framework process 10 to configure wizard 66 to only allow user 46 to select “next” button 258 once user 46 selects either “Yes” button 252 or “No” button 254 in response to the data request “Are You a US Citizen or Legal Resident Alien?”.

Continuing with the above-stated example, upon user 46 selecting “next” button 258 on third wizard page 250, fourth wizard page 300 of wizard 66 may be rendered that includes the data request “Please Provide Your Address” The data request “Please Provide Your Address” (as included within e.g., fourth wizard page 300 of wizard 66) may require that user 46 fill in a plurality of fields 302 that define e.g., the “Name”, “Street 1”, “Street 2”, “City”, “State” and “Zip Code” of user 46, followed by a selection of either “back” button 304, “next” button 306, or “quit” button 308. Again, administrator 64 may use wizard framework process 10 to configure wizard 66 to only allow user 46 to select “next” button 306 once user 46 fills in a requisite number of fields “Name”, “Street 1”, “Street 2”, “City”, “State” and “Zip Code” in response to the data request “Please Provide Your Address”.

Continuing with the above-stated example, upon user 46 selecting “next” button 306 on fourth wizard page 300, fifth wizard page 350 of wizard 66 may be rendered that includes the data request “Please Confirm Your Address” The data request “Please Confirm Your Address” (as included within e.g., fifth wizard page 350 of wizard 66) may require that user 46 select either “back” button 352, “quit” button 354 or “confirmed” button 356.

When administrator 64 configures wizard 66 using wizard framework process 10, the resulting wizard (i.e., wizard 66) may be remotely deployable for execution on the computer being used by the user executing the wizard. For example, as user 46 is executing wizard 66, wizard 66 may be executed on personal computer 38 (i.e., the personal computer being utilized by user 46). Accordingly, assume for illustrative purposes only that web server application 20 hosts a website (e.g., website 68) for a sporting goods retailer. Further, assume that user 46 uses web client application 22 to access website 68 and selects a “Stay Connected” link (not shown) within website 68. Web server application 20 may push wizard 66 to personal computer 38 via e.g., network 14, for subsequent execution on personal computer 38. For example, wizard 66 may be a JavaScript-based wizard that is executable on personal computer 38.

Accordingly, once received by personal computer 38, wizard 66 may be executed and the above-described wizard pages (i.e., wizard pages 150, 200, 250, 300, 350) may be rendered on personal computer 38. During execution of wizard 66, wizard 66 may gather the responses provided by the user (e.g., user 46) and may provide the various responses to a defined intended recipient (e.g., server computer 12) in a concurrent fashion (as will be discussed below) as opposed to a piece-meal fashion.

Specifically, when configuring wizard 66 using wizard framework process 10, administrator 66 may define 104 a computing device as the intended recipient of the responses provided by the user (e.g., user 46). For example, assume for illustrative purposes only that administrator 64 defines server computer 12 as the intended recipient of the responses provided by user 46 when wizard 66 is executed on personal computer 38. As discussed above, wizard 66 may gather the responses provided by the user and may provide the various responses to e.g., server computer 12 in a concurrent fashion, as opposed to a piece-meal fashion. Accordingly, the number of times that e.g., server computer 12 is interrupted may be reduced.

As used in the disclosure, “concurrent fashion” is intended to mean a non-“piece-meal” fashion. Accordingly, once a first response is received from user 46, instead of immediately providing the first response to server computer 12, the first response may be stored until e.g., the second response from user 20 is received. At this point, both the first and the second responses may be provided to server computer 12 (thus reducing server interruptions by 50%). Further increases in efficiency may be achieved by storing additional responses for subsequent submission to server computer 12. For example, the first through the fourth response may be stored until e.g., the fifth response from user 26 is received. At that point in time, all five responses may be provided to server computer 12 (thus reducing server interruptions by 80%). Accordingly, it may be advantageous to store as many responses as practical to increase efficiency. However, it is foreseeable that certain situations may necessitate contacting server computer 12. For example, assume that if a certain response is provided by a user (e.g., user 46) in response to a specific data request, an additional wizard may need to be executed on personal computer 38. Accordingly, upon receiving such a response from user 26, that response may be immediately provided to server computer 12 to effectuate obtaining the additional wizard.

When configuring wizard 66 using wizard framework process 10, administrator 64 may effectuate the concurrent providing of responses to e.g., server computer 12 in a variety of ways.

For example, administrator 64 may configure wizard 66 (using wizard framework process 10) to receive and store the individual responses and then combine the individual responses to form a combined response that is then provided to e.g., server computer 12. Accordingly and for illustrative purposes, once all five responses are received, they may be combined to form a combined response that may be provided to server computer 12.

Alternatively, administrator 64 may configure wizard 66 (using wizard framework process 10) to receive and store the individual responses, which are then sequentially provided to server computer 12. Accordingly and for illustrative purposes, once all five responses are received, they may be sequentially provided to server computer 12.

While wizard 66 is described above as including five wizard pages in which all of the wizard pages are rendered during the execution of the wizard, this is for illustrative purposes only, as other configurations are possible and are considered to be within the scope of this disclosure. For example, assume that the wizard generated was a political poll, in which the first request is “Are you a Democrat or a Republican”. If the next request concerns which candidate you support in the presidential primary, the specific wizard page rendered will vary depending upon whether you respond as being a Democrat or a Republican. Accordingly, the specific request defined within a wizard page of a wizard may vary depending upon a response previously-submitted by the user.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method comprising:
defining a first data request for presentation within a wizard, wherein the first data request solicits a first response from a user of the wizard;
defining at least a second data request for presentation within the wizard after receipt of the first response from the user, wherein the at least a second data request solicits at least a second response from the user of the wizard; and
defining a computing device as the intended recipient of the first response and the at least a second response, wherein the first response and the at least a second response are concurrently provided to the computing device.

2. The method of claim 1 wherein the at least a second data request is based, at least in part, upon the first response from the user of the wizard.

3. The method of claim 1 wherein concurrently providing the first response and the at least a second response to the computing device includes:
receiving and storing the first response;
receiving and storing the at least a second response;
combining the first response and the at least a second response to form a combined response; and
providing the combined response to the computing device.

4. The method of claim 1 wherein concurrently providing the first response and the at least a second response to the computing device includes:
receiving and storing the first response;
receiving and storing the at least a second response;
sequentially providing the first response and the at least a second response to the computing device.

5. The method of claim 1 wherein concurrently providing the first response and the at least a second response to the computing device includes:
providing the first response to the computing device only after the at least a second response is received from the user.

6. The method of claim 1 wherein the wizard is a multi-page wizard that defines a first wizard page and at least a second wizard page.

7. The method of claim 6 wherein the first data request is defined within the first wizard page.

8. The method of claim 6 wherein the at least a second data request is defined within the at least a second wizard page.

9. The method of claim 1 wherein the computing device is a webserver.

10. The method of claim 1 wherein the wizard is a JavaScript-based wizard.

11. A computer program product residing on a computer readable medium having a plurality of instructions stored thereon, which, when executed by a processor, cause the processor to perform operations comprising:
defining a first data request for presentation within a wizard, wherein the first data request solicits a first response from a user of the wizard;
defining at least a second data request for presentation within the wizard after receipt of the first response from the user, wherein the at least a second data request solicits at least a second response from the user of the wizard; and
defining a computing device as the intended recipient of the first response and the at least a second response, wherein the first response and the at least a second response are concurrently provided to the computing device.

12. The computer program product of claim 11 wherein the at least a second data request is based, at least in part, upon the first response from the user of the wizard.

13. The computer program product of claim 11 wherein the instructions for concurrently providing the first response and the at least a second response to the computing device include instructions for:
receiving and storing the first response;
receiving and storing the at least a second response;
combining the first response and the at least a second response to form a combined response; and
providing the combined response to the computing device.

14. The computer program product of claim 11 wherein the instructions for concurrently providing the first response and the at least a second response to the computing device include instructions for:
receiving and storing the first response;
receiving and storing the at least a second response;
sequentially providing the first response and the at least a second response to the computing device.

15. The computer program product of claim 11 wherein the instructions for concurrently providing the first response and the at least a second response to the computing device include instructions for:
providing the first response to the computing device only after the at least a second response is received from the user.

16. The computer program product of claim 11 wherein the wizard is a multi-page wizard that defines a first wizard page and at least a second wizard page.

17. The computer program product of claim 16 wherein the first data request is defined within the first wizard page.

18. The computer program product of claim 16 wherein the at least a second data request is defined within the at least a second wizard page.

19. The computer program product of claim 11 wherein the computing device is a webserver.

20. The computer program product of claim 11 wherein the wizard is a JavaScript-based wizard.
